(19) United States
(12) Patent Application Publication
(10) Pub. No.: US 2013/0264822 A1
(43) Pub. Date: Oct. 10, 2013

(54) WIND POWER GENERATING SYSTEM

(71) Applicants: Chih-Hung HSIAO, Kuei San (TW); Cheng-Chieh CHAN, Kuei San (TW); Yun-Chi HUNG, Kuei San (TW)

(72) Inventors: Chih-Hung HSIAO, Kuei San (TW); Cheng-Chieh CHAN, Kuei San (TW); Yun-Chi HUNG, Kuei San (TW)

(21) Appl. No.: 13/547,443

(22) Filed: Jul. 12, 2012

(30) Foreign Application Priority Data
Apr. 10, 2012 (TW) 101112543

(51) Int. Cl. H02P 9/04

(52) U.S. Cl. 290/44

(57) ABSTRACT

A wind power generating system includes a wind turbine, a control unit and a load unit. The wind turbine includes a blade module and an electric generator, in which the blade module is driven by an external wind force to in turn drive the electric generator for generating a power. The control unit controls the wind turbine according to operation characteristics and a speed of the external wind force, such that the wind turbine operates in a normal mode, a rotational speed controlling mode, or a safe mode. The load unit is electrically coupled to the control unit and receives the power generated by the wind turbine.

### RELATED APPLICATIONS

This application claims priority to Taiwan Patent Application Serial Number 101112543, filed Apr. 10, 2012, which is herein incorporated by reference.

### BACKGROUND

1. Technical Field

The present disclosure relates to a power generating system, and especially relates to a wind power generating system.

2. Description of Related Art

With the raised level of environmental consciousness in recent times, renewable energy technologies have developed rapidly. Among the different renewable energy technologies, wind power generation is relatively easy to realize and produces no pollution. With wind power generation, an external wind force is converted into a power output through fan blades of a wind turbine being driven by the wind force, after which a load (such as a battery or a transmission grid) is provided with a predetermined amount of electricity.

However, the rotational speed of the fan blades of the wind turbine increases when the external wind force increases, so that the power generated by the wind turbine may exceed a sustainable power range of the load, causing a breakdown of equipment in the power generation system. Furthermore, when the external wind force is excessive, the wind turbine may be unable to handle the resulting extreme rotational speed, such that the wind turbine operates out of control or suffers damage.

Therefore, a heretofore unaddressed need exists in the art to address the aforementioned deficiencies and inadequacies.

### SUMMARY

An aspect of the present disclosure provides a wind power generating system, which includes a wind turbine, a control unit, and a load unit. The wind turbine includes a blade module and an electric generator, in which the blade module is driven by an external wind force to in turn drive the electric generator for generating a power. The control unit is electrically coupled to the wind turbine and configured for controlling the wind turbine according to a rotational speed, an output power, an extraction current and a noise of the wind turbine, and a speed of the external wind force. When a value of at least one of the rotational speed, the output power, the extraction current and the noise of the wind turbine exceeds a threshold value, the control unit controls the wind turbine to switch from operating in a normal mode to operating in a rotational speed controlling mode, and when the speed of the external wind force is larger than a predetermined wind speed, the control unit controls the wind turbine to switch from operating in the rotational speed controlling mode to operating in a safe mode. The load unit is electrically coupled to the control unit and configured for receiving the power generated by the wind turbine.

According to an embodiment in the present disclosure, when the power generated by the wind turbine is larger than a sustainable value of the load unit, the rotational speed of the wind turbine is larger than a predetermined safe rotational speed, the extraction current of the wind turbine is larger than a sustainable value of a winding, or the noise generated by the wind turbine is larger than a predetermined normal value, the control unit controls the wind turbine to switch from operating in the normal mode to operating in the rotational speed controlling mode.

According to an embodiment in the present disclosure, when the wind turbine operates in the rotational speed controlling mode, the output power of the wind turbine is maintained substantially at a predetermined value.

According to an embodiment in the present disclosure, the wind turbine generates the power according to a wind speed power curve in the normal mode, and the wind speed power curve indicates a maximum output power of the wind turbine corresponding to the speed of the external wind.

According to an embodiment in the present disclosure, the load unit further includes a conversion unit, a transmission grid, and an electricity storing unit. The conversion unit is configured for converting the power generated by the wind turbine to a power supply. The transmission grid is electrically coupled to the conversion unit and configured for receiving the power supply outputted from the conversion unit. The electricity storing unit is coupled to the conversion unit in parallel and configured for storing the power generated by the wind turbine.

According to an embodiment in the present disclosure, the wind power generating system further includes a brake unit. The brake unit is electrically coupled to the wind turbine and the control unit, wherein the control unit is further configured for outputting a control signal, and the brake unit controls the rotational speed of the wind turbine according to the control signal.

According to an embodiment in the present disclosure, the control signal generated by the control unit is a switch pulse signal or a pulse width modulation signal.

According to an embodiment in the present disclosure, the control unit is configured for distributing a portion of the power generated by the wind turbine to the brake unit for modulating the power transmitted by the wind turbine to the load unit.

According to an embodiment in the present disclosure, the control unit modulates a switch period of the brake unit in the rotational speed controlling mode for controlling the rotational speed of the wind turbine.

According to an embodiment in the present disclosure, the control unit is configured for controlling the wind turbine to operate in a slow speed operation state utilizing a maximum torque extraction technique performed by the brake unit, such that the wind turbine operates in the safe mode.

### BRIEF DESCRIPTION OF THE DRAWINGS

In order to make the above description, other purposes, features, advantages, and embodiments easier to be understood, the appended drawings are illustrated as follows:

FIG. 1 shows a schematic circuit block diagram of a wind power generating system according to an embodiment of the present disclosure.

FIG. 2 shows a flow chart of a method for controlling a wind power generating system according to an embodiment of the present disclosure.

FIG. 3 shows a graph of wind speed versus power of a wind turbine according to an embodiment of the present disclosure.

FIG. 4 shows a graph of output powers of a wind turbine in a normal mode, a rotational speed controlling mode, and a safe mode according to an embodiment of the present disclosure.

### DETAILED DESCRIPTION

In the following description, specific details are presented to provide a thorough understanding of the embodiments of the present disclosure. Persons of ordinary skill in the art will recognize, however, that the present disclosure can be practiced without one or more of the specific details, or in combination with other components. Well-known implementations or operations are not shown or described in detail to avoid obscuring aspects of various embodiments of the present disclosure.

As used herein, “substantially” shall generally mean within 20 percent, preferably within 10 percent, and more preferably within 5 percent of a given value or range. Numerical quantities given herein are approximate, meaning that the term “substantially” can be inferred if not expressly stated.

In the following description and claims, the terms “coupled” and “connected,” along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

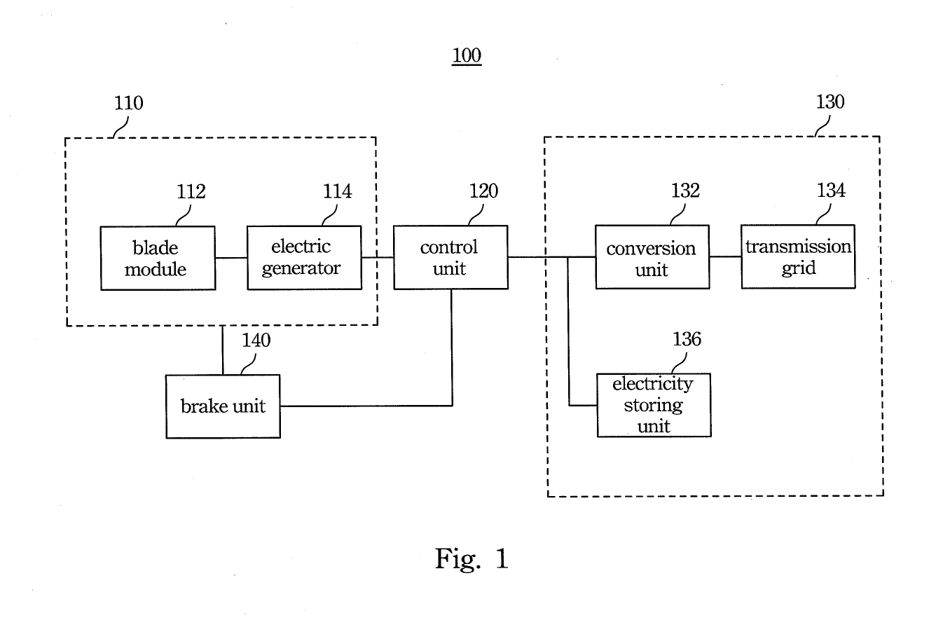

FIG. 1 shows a schematic circuit block diagram of a wind power generating system 100 according to an embodiment of the present disclosure. The wind power generating system 100 includes a wind turbine 110, a control unit 120, and a load unit 130. The wind turbine 110 includes a blade module 112 and an electric generator 114, in which the blade module 112 is driven by an external wind force to in turn drive the electric generator 114 to generate a power. The control unit 120 is electrically coupled to the wind turbine 110 and configures the wind turbine 110 to operate in one of a normal mode, a rotational speed controlling mode, and a safe mode according to a rotational speed, an output power, an extraction current, a noise of the wind turbine 110, and an intensity of the external wind force. The load unit 130 is electrically coupled to the control unit 120 for receiving the power generated by the wind turbine 110.

It is noted that the blade module 112 can include a plurality of fan blades in the present embodiment. The external wind force acts on the fan blades to generate a torque. The blade module 112 is driven by the torque to rotate and to thereby drive the electric generator 114 to generate power through a transmission device (not shown).

In the present embodiment, the load unit 130 includes a conversion unit 132, a transmission grid 134, and an electricity storing unit 136. The conversion unit 132 can be an inverter for converting the power generated by the wind turbine 110 to a required power supply (such as an AC power supply) which can be provided to the transmission grid 134. The transmission grid 134 is electrically coupled to the conversion unit 132 for receiving the power supply outputted from the conversion unit 132. The electricity storing unit 136 is coupled to the conversion unit 132 in parallel for storing the power generated by the wind turbine 110. In practice, the electricity storing unit 136 can be a battery.

In one embodiment of the present disclosure, the wind turbine 100 can further include a brake unit 140. The brake unit 140 is electrically coupled to the wind turbine 110 and the control unit 120, and configured for controlling the rotational speed of the wind turbine 110. In an embodiment, the control unit 120 is further configured for outputting a control signal, and the brake unit 140 controls the rotational speed of the wind turbine 110 according to the control signal. For example, the control unit 120 can output a switch pulse signal or a pulse width modulation (PWM) signal to the brake unit 140 to modulate a switch period of the brake unit 140 and to further control the rotational speed of the wind turbine 110 when the control unit 120 determines that the rotational speed of the wind turbine 110 is too high and needs to be lowered. Moreover, the control unit 120 can further distribute a portion of the power generated by the wind turbine 110 to the brake unit 140 for modulating the power transmitted by the wind turbine 110 to the load unit 130.

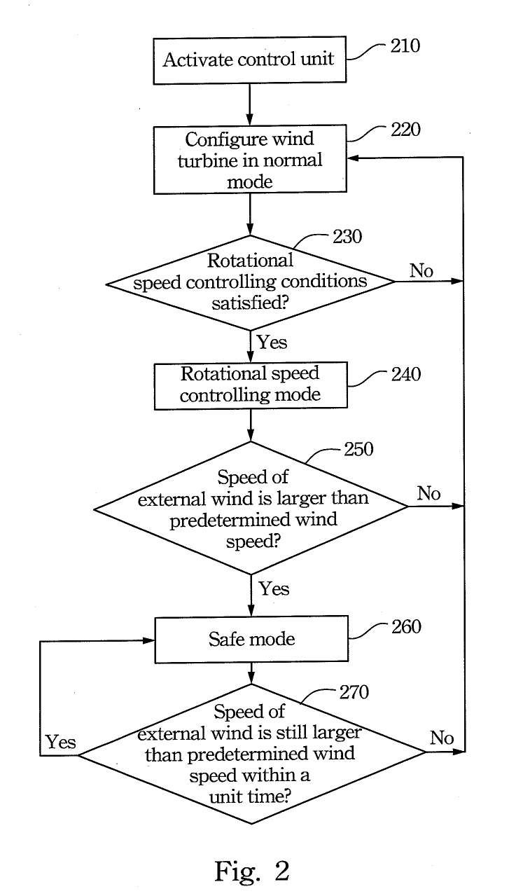

FIG. 2 shows a flow chart of a method for controlling a wind power generating system according to an embodiment of the present disclosure. For the description to follow, it is assumed that the controlling method is applied to the wind power generating system 100 shown in FIG. 1. Details with respect to the wind power generating system 100 of FIG. 1 will not be repeated. It is noted that the controlling method may also be applied to a wind power generating system that is similar in structure to the wind power generating system 100 of FIG. 1, and the present invention is not limited in this regard.

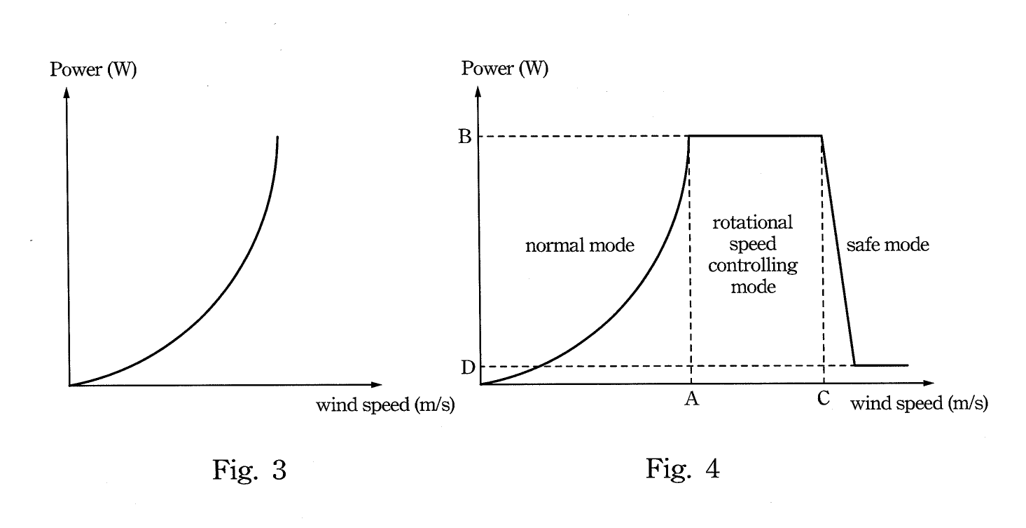

First, in step 210, the control unit 120 is activated for configuring an operation mode of the wind turbine 110. Next, in step 220, the wind turbine 110 is configured to operate in the normal mode, so that the wind turbine 110 can generate power according to a curve of wind speed versus power of a wind turbine shown in FIG. 3. FIG. 3 shows a graph of wind speed versus power of the wind turbine 110 according to an embodiment of the present disclosure. In the present embodiment, the rotational speed of the blade module 112 increases with an increase of the external wind force, such that the power generated by the electric generator 114 also increases. The graph of wind speed versus power is a maximum power curve where the blade module 112 and the electric generator 114 match at each corresponding wind speed, so that the wind turbine 110 has a maximum power output at each corresponding wind speed.

Next, in step 230, the control unit 120 determines whether at least one of a plurality of rotational speed controlling conditions is satisfied. For example, the rotational speed controlling conditions can include the following: the power generated by the wind turbine 110 is larger than a sustainable value of the load unit 130 (e.g., 100 MW), the rotational speed of the wind turbine 110 is larger than a predetermined safe rotational speed (e.g., 1200 RPM), the extraction current of the wind turbine 110 is larger than a sustainable value of a winding (e.g., 30 A), and the noise generated by the wind turbine 110 (e.g., a mechanical noise or a pneumatic noise) is larger than a predetermined normal value (e.g., 75 dB). If at least one of the rotational speed controlling conditions is satisfied, step 240 is performed, in which the wind turbine 110 is switched from operating in the normal mode to operating in the rotational speed controlling mode for controlling the rotational speed of the wind turbine 110, so that at least one of the following conditions is satisfied: the power generated by the wind turbine 110 is smaller than a sustainable power range of the load unit 130, the rotational speed of the wind turbine 110 is smaller than the predetermined safe rotational speed, the extraction current of the wind turbine 110 is smaller than a sustainable current range of the winding, and the noise generated by the wind turbine 110 is smaller than the predetermined normal value. As a result, the output power of the wind turbine 110 is maintained in a safe power range. In step 230, if the at least one of rotational speed controlling conditions is not satisfied, the operation returns to step 220.

Thereafter, in step 250, the control unit 120 determines whether the speed of the external wind is larger than a predetermined wind speed (e.g., 18 m/s). If so, step 260 is performed to switch the wind turbine 110 from operating in the rotational speed controlling mode to operating in the safe mode for reducing the rotational speed of the wind turbine 110, thereby ensuring the safety of the entire wind power generating system 100. In step 250, if the speed of the external wind is not larger than the predetermined wind speed, the operation returns to step 220.

FIG. 4 shows a graph of output powers of the wind turbine 110 in the normal mode, the rotational speed controlling mode, and the safe mode according to an embodiment of the present disclosure. For example, when the speed of the external wind is smaller than the wind speed at point A (e.g., 12 m/s), the wind turbine 110 operates in the normal mode. In this range of external wind speeds, the output power of the wind turbine 110 increases with increases in the wind speed and the wind turbine 110 has a maximum power output at the corresponding wind speed.

When the speed of the external wind is larger than the wind speed at point A but smaller than that at point C (e.g., 18 m/s) and one of the aforementioned rotational speed controlling conditions is satisfied, the control unit 120 switches the wind turbine 110 from operating in the normal mode to operating in the rotational speed controlling mode for controlling the rotational speed of the wind turbine 110, so that the output power does not increase with increases in the wind speed. It is noted that the control unit 120 can provide a control signal for the brake unit 140 in the rotational speed controlling mode by modulating the switch period of the brake unit 140 to control the rotational speed of the wind turbine 110. Furthermore, the control unit 120 controls the wind turbine 110 in order that the maximum power curve of the wind turbine 110 is shifted utilizing a maximum power point shift technique, so that the rotational speed and the output power of the wind turbine 110 can still be maintained in the safe power range with the increase of the wind speed, and the wind turbine 110 no longer generates power according to the curve of wind speed versus power shown in FIG. 3. Therefore, the output power of the wind turbine 110 can be maintained at level B in FIG. 4 while in the rotational speed controlling mode.

When the speed of the external wind is larger than the wind speed at point C, the rotational speed of the wind turbine 110 can no longer be controlled by the aforementioned rotational speed controlling mode, that is, the rotational speed of the wind turbine 110 is such that the wind turbine 110 is uncontrollable and may even suffer damage. When this occurs, the control unit 120 can switch the wind turbine 110 from operating in the rotational speed controlling mode to operating in the safe mode, and can control the wind turbine 110 to operate in a slow speed operation state utilizing a maximum torque extraction technique performed by the brake unit 140 and/or the electric generator 114. That is, the control unit 120 lowers the speed of the wind turbine 110 to a slow speed rotation state to protect the wind power generating system 100, so that the wind turbine 110 can be maintained in the safe mode with a low power output indicated at point D shown in FIG. 4.

In an embodiment of the present disclosure, the aforementioned method further includes detecting whether the speed of the external wind is still larger than the predetermined wind speed within a unit time, as shown in step 270 of FIG. 2. If so, step 260 is performed so that the wind turbine 110 is maintained in the safe mode. If not, the operation returns to step 220.

For example, in a typhoon, the wind speed often exceeds a maximum sustainable wind speed (e.g., 18 m/s) of the wind turbine 110. Therefore, during a typhoon, the control unit 120 can switch the wind turbine to operate in the safe mode according to a detected average or instantaneous value of the wind. Thereafter, the control unit 120 can detect whether the speed of the external wind is still larger than the predetermined wind speed within the unit time (e.g., 1, 12, or 24 hours), in effect checking whether the typhoon has subsided. For example, when the average speed of the external wind detected within 12 hours is not larger than the predetermined wind speed, this indicates that the typhoon has gone away, after which the operation returns to step 220 so that the wind turbine 110 is controlled to operate in the normal mode.

In the aforementioned embodiment of the present disclosure, the operation mode of the wind turbine can be configured according to the aforementioned rotational speed controlling conditions and the intensity of the external wind, such that the wind turbine can be operated in one of the normal mode, the rotational speed controlling mode, and the safe mode, to thereby adapt to changes in the environment and maintain normal operation of the wind power generating system.

The steps described above are not necessarily recited in the sequence in which the steps are performed. That is, unless the sequence of the steps is expressly indicated, the sequence of the steps is interchangeable, and all or part of the steps may be simultaneously, partially simultaneously, or sequentially performed.

Although the disclosure has been disclosed by the aforementioned embodiments, they are not to be considered limiting of the disclosure. Any skilled in the art can present any variation and modification without departing from the spirit and scope of the disclosure. Therefore, both the foregoing general description and the following detailed description are by examples, and are intended to provide further explanation of the disclosure as claimed.

What is claimed is:

1. A wind power generating system, comprising:
a wind turbine comprising a blade module and an electric generator, wherein the blade module is driven by an external wind force to in turn drive the electric generator for generating a power;
a control unit electrically coupled to the wind turbine and configured for controlling the wind turbine according to a rotational speed, an output power, an extraction current and a noise of the wind turbine, and a speed of the external wind, wherein when a value of at least one of the rotational speed, the output power, the extraction current and the noise of the wind turbine exceeds a threshold value, the control unit controls the wind turbine to switch from operating in a normal mode to operating in a rotational speed controlling mode, and when the speed of the external wind is larger than a predetermined wind speed, the control unit controls the wind turbine to switch from operating in the rotational speed controlling mode to operating in a safe mode; and
a load unit electrically coupled to the control unit and configured for receiving the power generated by the wind turbine.

2. The wind power generating system of claim 1, wherein when the power generated by the wind turbine is larger than a sustainable value of the load unit, the rotational speed of the wind turbine is larger than a predetermined safe rotational speed, the extraction current of the wind turbine is larger than a sustainable value of a winding, or the noise generated by the wind turbine is larger than a predetermined normal value, the control unit controls the wind turbine to switch from operating in the normal mode to operating in the rotational speed controlling mode.

3. The wind power generating system of claim 2, wherein when the wind turbine operates in the rotational speed controlling mode, the power generated by the wind turbine is smaller than a sustainable value of the load unit, the rotational speed of the wind turbine is smaller than a predetermined safe rotational speed, the extraction current of the wind turbine is smaller than a sustainable value of a winding, or the noise generated by the wind turbine is smaller than a predetermined normal value.

4. The wind power generating system of claim 3, wherein when the wind turbine operates in the rotational speed controlling mode, the output power of the wind turbine is maintained substantially at a predetermined value.

5. The wind power generating system of claim 4, wherein when the wind turbine operates in the rotational speed controlling mode, the control unit is configured for shifting the maximum power curve of the wind turbine.

6. The wind power generating system of claim 5, wherein the wind turbine generates the power according to a wind speed power curve in the normal mode, and the wind speed power curve indicates a maximum output power of the wind turbine corresponding to the speed of the external wind.

7. The wind power generating system of claim 2, wherein the wind turbine generates the power according to a wind speed power curve in the normal mode, and the wind speed power curve indicates a maximum output power of the wind turbine corresponding to the speed of the external wind.

8. The wind power generating system of claim 1, wherein the wind turbine generates the power according to a wind speed power curve in the normal mode, and the wind speed power curve indicates a maximum output power of the wind turbine corresponding to the speed of the external wind.

9. The wind power generating system of claim 1, wherein the load unit further comprises:
a conversion unit configured for converting the power generated by the wind turbine to a power supply;
a transmission grid electrically coupled to the conversion unit and configured for receiving the power supply outputted from the conversion unit; and
an electricity storing unit coupled to the conversion unit in parallel and configured for storing the power generated by the wind turbine.

10. The wind power generating system of claim 1, further comprising:
a brake unit electrically coupled to the wind turbine and the control unit, wherein the control unit is further configured for outputting a control signal, and the brake unit controls the rotational speed of the wind turbine according to the control signal.

11. The wind power generating system of claim 10, wherein the control signal generated by the control unit is a switch pulse signal or a pulse width modulation signal.

12. The wind power generating system of claim 10, wherein the control unit is configured for distributing a portion of the power generated by the wind turbine to the brake unit for modulating the power transmitted by the wind turbine to the load unit.

13. The wind power generating system of claim 10, wherein the control unit modulates a switch period of the brake unit in the rotational speed controlling mode for controlling the rotational speed of the wind turbine.

14. The wind power generating system of claim 10, wherein the control unit is configured for controlling the wind turbine to operate in a slow speed operation state utilizing a maximum torque extraction technique performed by the brake unit, such that the wind turbine operates in the safe mode.

15. A wind power generating system, comprising:
a wind turbine comprising a blade module and an electric generator, wherein the blade module is driven by an external wind force to in turn drive the electric generator for generating a power;
a control unit electrically coupled to the wind turbine and configured for controlling the wind turbine according to a rotational speed, an output power, an extraction current and a noise of the wind turbine, and a speed of the external wind, wherein when a value of at least one of the rotational speed, the output power, the extraction current and the noise of the wind turbine exceeds a threshold value, the control unit controls the wind turbine to switch from operating in a normal mode to operating in a rotational speed controlling mode, and when the speed of the external wind is larger than a predetermined wind speed, the control unit controls the wind turbine to switch from, operating in the rotational speed controlling mode to operating in a safe mode;
a load unit comprising a conversion unit, a transmission grid, and an electricity storing unit, wherein the conversion unit is configured for converting the power generated by the wind turbine to a power supply, the transmission grid electrically coupled to the conversion unit is configured for receiving the power supply outputted from the conversion unit, and the electricity storing unit coupled to the conversion unit in parallel is configured for storing the power generated by the wind turbine; and
a brake unit electrically coupled to the wind turbine and the control unit, wherein the control unit is further configured for outputting a control signal, and the brake unit controls the rotational speed of the wind turbine according to the control signal.

16. The wind power generating system of claim 15, wherein the wind turbine generates the power according to a wind speed power curve in the normal mode, and the wind speed power curve indicates a maximum output power of the wind turbine corresponding to the speed of the external wind.

17. The wind power generating system of claim 15, wherein the control signal generated by the control unit is a switch pulse signal or a pulse width modulation signal.

18. The wind power generating system of claim 15, wherein the control unit is configured for distributing a portion of the power generated by the wind turbine to the brake unit for modulating the power transmitted by the wind turbine to the load unit.

19. The wind power generating system of claim 15, wherein the control unit modulates a switch period of the brake unit in the rotational speed controlling mode for controlling the rotational speed of the wind turbine.

20. The wind power generating system of claim 15, wherein the control unit is configured for controlling the wind turbine to operate in a slow speed operation state utilizing a maximum torque extraction technique performed by the brake unit, such that the wind turbine operates in the safe mode.
